(19) United States
(12) Patent Application Publication
(10) Pub. No.: US 2020/0361695 A1
(43) Pub. Date: Nov. 19, 2020

(54) INSULATING PACKING MATERIAL MADE OF PAPER

(71) Applicant: Danco Packaging Supply Company, Carol Stream, IL (US)

(72) Inventor: Daniel Edward Mulvey, Elk Grove Village, IL (US)

(21) Appl. No.: 16/876,022

(22) Filed: May 16, 2020

Related U.S. Application Data
(60) Provisional application No. 62/849,284, filed on May 17, 2019.

(51) Int. Cl. B65D 81/38; B32B 29/00

(52) U.S. Cl. CPC B65D 81/3813; B32B 2307/304; B32B 2553/00; B32B 29/005

(57) ABSTRACT

A packing material includes an outer covering formed of paper and configured to have a length, a width, a thickness, and an interior volume defined within the outer covering. The packing material also includes a plurality of insulating layers each formed of paper substrate and stacked and disposed within the interior volume. Each of the plurality of insulating layers is configured having a three-dimensional out of plane configuration with an expanded thickness.

### RELATED APPLICATION DATA

This patent is entitled to the benefit of and claims priority to co-pending U.S. Provisional Application Ser. No. 62/849,284 filed May 17, 2019 and entitled “Insulated Packing Material Made of Paper.” The entire contents of this prior filed application are hereby incorporated herein by reference.

### BACKGROUND

### 1. Field of the Disclosure

The present disclosure is generally directed to packing material for shipping containers, and more particularly to a packing material made from paper or recycled paper for use in shipping containers. The packing material provides insulating characteristics for temperature sensitive shipped products.

### 2. Description of Related Art

It is becoming increasingly common for individuals to order products using the internet and to have such products delivered direct to the consumer. Many companies exist that provide products for sale via the internet. Virtually any product is now available for purchase on-line and for delivery direct to the consumer. AMAZON.com is the primary example, but many, many more companies are using this business model to have their products reach consumers.

Some products, such as prepared foods, bulk foods, specialty foods, and the like are shipped to the consumer while frozen or while maintained at a specific temperature. Many food products must be maintained and shipped at below about 40 degrees Fahrenheit (° F.) to meet government standards and requirements regarding food safety and to keep the food items fresh until the package is opened by the consumer. Ordering prepared meals from a source and having the meals shipped direct to the consumer is becoming increasingly common as well.

These types of products are typically shipped in a container, such as a box. In many instances, the boxes are provided in a range of standard sizes, whereas the products are provided in a wide range of shapes and sizes. As a result, the products are often significantly smaller than the size of the container used for shipment. Packing material is thus commonly added to the box to fill the voids in the container. The packing material helps to hold the products in one place inside the container and to keep the products from jostling about or even hitting the sides of the container during transport and shipping.

It is also becoming more common for companies and consumers to look for and utilize shipping containers and packing materials that are ‘green’, i.e., that are made from recycled materials and/or are recyclable after use. Also, shipping containers often include cushioning packing material to help protect the contents of the containers during shipping. For example, crumpled paper, conventional plastic bubble wrap, and more recent air-filled pillow-like sheet or strip cushion packing material are commonly used. The crumpled paper may sometimes be made from recycled paper product and/or may be recyclable by the consumer. However, the bubble wrap and the air-filled plastic pillows or cushions are typically not ‘green’.

None of these conventional packing materials provide adequate insulation suitable for shipping temperature sensitive products. Some packing materials exist that are intended to provide an insulation function. In one example, RENEWLINER™ is an insulating packing material for shipping. The product includes two thin PET film layers that sandwich a recycled PET staple fiber material. The product is recyclable. However, the bulk material is expensive to obtain and to manufacture and the finished product is also expensive to manufacture. Further, the insulating properties are, at best, merely adequate.

In another example, HOME CHEF, HELLO FRESH, BLUE APRON and other such providers deliver prepared meals direct to consumers in boxes. The boxes include the meal in a plastic container, one or more ice packs, and an insulated liner. The insulated liners have an outer plastic film layer that is filled with recycled cotton and denim fabric. The liners are relatively bulky and heavy, which increases the shipping costs. To dispose of the insulated liners, the consumer must cut open the film layer, remove the filler, and recycle the film layer with the consumer's other plastic bags. The recycled cotton and denim fabric filler is thrown in the consumer's regular trash, which will head to a landfill.

### SUMMARY

In one example according to the teachings of the present disclosure, a packing material includes an outer covering formed of paper and configured to have a length, a width, a thickness, and an interior volume defined within the outer covering. The packing material also includes a plurality of insulating layers each formed of paper substrate and stacked and disposed within the interior volume. Each of the plurality of insulating layers is configured having a three-dimensional out of plane configuration with an expanded thickness.

In one example, the outer covering can be formed of recycled paper.

In one example, the outer covering can be formed of recyclable paper.

In one example, the outer covering can be formed of both recycled and recyclable paper.

In one example, the plurality of insulating layers can each be formed of recycled paper.

In one example, the plurality of insulating layers can each be formed of recyclable paper.

In one example, the plurality of insulating layers can each be formed of both recycled and recyclable paper.

In one example, the plurality of insulating layers and the outer covering can each be formed of recycled paper.

In one example, the plurality of insulating layers and the outer covering can each be formed of recyclable paper.

In one example, the plurality of insulating layers and the outer covering can each be formed of both recycled and recyclable paper.

In one example, the outer covering can be each made from 100% recycled and/or recyclable paper.

In one example, the plurality of insulating layers can each be made from 100% recycled and/or recyclable paper.

In one example, the outer covering and the plurality of insulating layers can each be made from 100% recycled and recyclable paper.

In one example, the outer covering can be a sheet of paper folded or wrapped unto itself to form the interior volume and can include a lengthwise seam.

In one example, the outer covering can be a sheet of paper folded or wrapped unto itself to form the interior volume and can include widthwise ends seams.

In one example, the outer covering can include one or more sealed seams such that the interior volume can be a closed and sealed space.

In one example, each of the plurality of insulating layers can be an expanded sheet of paper material having a plurality of slits.

In one example, the plurality of insulating layers can be formed by layering a stack of individual insulating layers of material.

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that are equally effective to achieve the objectives and that may fall within the scope of the disclosure. Objects, features, and advantages of the present disclosure will become apparent upon reading the following description in conjunction with the drawing figures, in which:

FIG. 1 shows a perspective view of one example of a shipping container in the form of an opened box, and including a paper based insulated packing material constructed in accordance with the teachings of the present disclosure.

FIG. 2 shows a cross-section taken along lines 2-2 of the container of FIG. 1, but with the box closed.

FIG. 3 shows a perspective view of a length of the packing material shown in FIG. 1 and removed from the shipping container and laid flat.

FIG. 4 shows a cross-section taken along lines 4-4 of the packing material of FIG. 3 and depicting a plurality of insulating layers within an outer covering of the packing material.

FIG. 5 shows a plan view of a sheet of paper substrate material formed with a multitude of slits or cuts and utilized to create one of the plurality of insulating layers depicted in FIG. 4.

FIG. 6 shows a close-up perspective view of one example of an insulating layer of material according to the teachings of the present disclosure and formed from the sheet of paper substrate material of FIG. 5.

FIG. 7 show a perspective and exploded view of another example of a shipping container in the form of a box and including two lengths of the insulated packing material of FIG. 3.

FIG. 8 shows a cross-section taken along lines 8-8 of the container of FIG. 7, but with the box assembled and closed.

### DETAILED DESCRIPTION OF THE DISCLOSURE

This application discloses a packing material that solves or improves upon one or more of the above-noted and/or other problems and disadvantages with prior known and existing insulated packing materials. The disclosed packing material provides excellent insulating properties or characteristics. The disclosed packing material can be formed entirely of a bulk paper material. The bulk paper material and, thus, the insulated packing material, can be made entirely from 100% recycled paper. The disclosed insulated packing material can also be made from paper that is entirely 100% recyclable after use. The disclosed packing material can be made from recycled paper that is also recyclable. The disclosed packing material can also be biodegradable, i.e., compostable or decomposable. The disclosed packing material is light weight and thus adds relatively little to the weight, and thus the cost, of a product and container being shipped. The disclosed packing material is also relatively simple to manufacture. These and other objects, features, and advantages of the present disclosure will become apparent to those having ordinary skill in the art upon reading this disclosure.

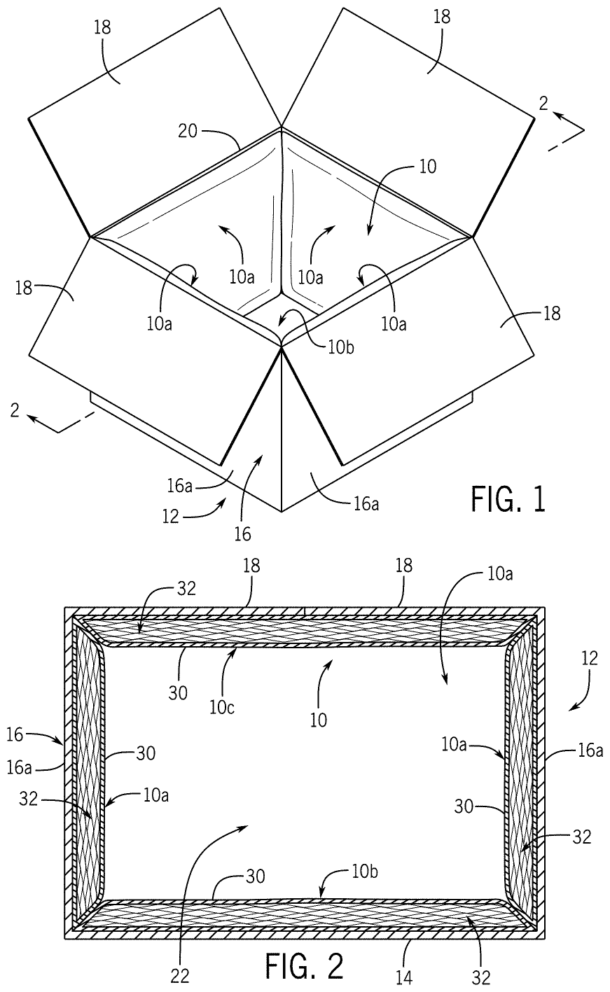

Turning now to the drawings, FIGS. 1 and 2 show a shipping container that includes an insulated packing material 10 according to the teachings of the present disclosure. The shipping container in this example is in the form of a corrugated cardboard or paperboard box 12. The box 12 is shown in FIG. 1 in an opened condition and in FIG. 2 in a closed condition. The box 12 is depicted including multiple pieces of the packing material 10 received therein. The box 12 has a conventional construction including a bottom 14, an upstanding wall 16 extending up from the bottom, and an open top. The open top can be closed by overlapping one or more flaps 18, which are connected to top portions of the side wall 16. In this example, the box 12 has a conventional square box shape and the wall 16 includes four rectangular sides 16a. A flap 18 extends from a top edge 20 of each side 16a and the flaps are used to close the open top. The box 12 or other shipping container can vary greatly from this disclosed example in size, shape, and construction material. Other sizes, shapes, and types of shipping containers and boxes can be utilized with the packing material 10 within the spirit and scope of the present disclosure.

The shipping container or box 12 defines an interior space 22 for holding products or materials to be shipped. The entire exposed surfaces of the box 12 in the interior space 22 can be lined with the packing material 10, if desired, or only portions of the surfaces may include the packing material. As shown in FIGS. 1 and 2, one length of the packing material 10 can be folded three times to form four distinct sections 10a of the packing material. The length of packing material 10 can be placed within the box, with each section 10a residing vertically against one of the sides 16a of the upstanding side wall 16. One rectangular piece 10b of the packing material can be disposed on the interior surface of the bottom 14 of the box. Another rectangular piece 10c can be disposed over the contents to be shipped and within the open top of the box 12 before the closure flaps 18 are used to close the box. In this manner and in this example, three separate pieces 10a, 10b, and 10c are used to form the packing material 10 and to completely encompass the goods or product to be shipped in the box 12.

The packing material 10 pieces can be loosely placed in the box 12.

Alternatively, one or more sections or pieces 10a, 10b, 10c of the packing material 10 can be adhered to a surface of the box. The packing material 10 can be provided in more or fewer pieces, as desired and/or to accommodate a particular shipping purpose, container, and/or product. The container or box size, shape, and type can vary from the example shown. The products or goods to be shipped can also vary in size, shape, and type. The desired or required insulating characteristics of the packing material may also vary according to the needs of a given application.

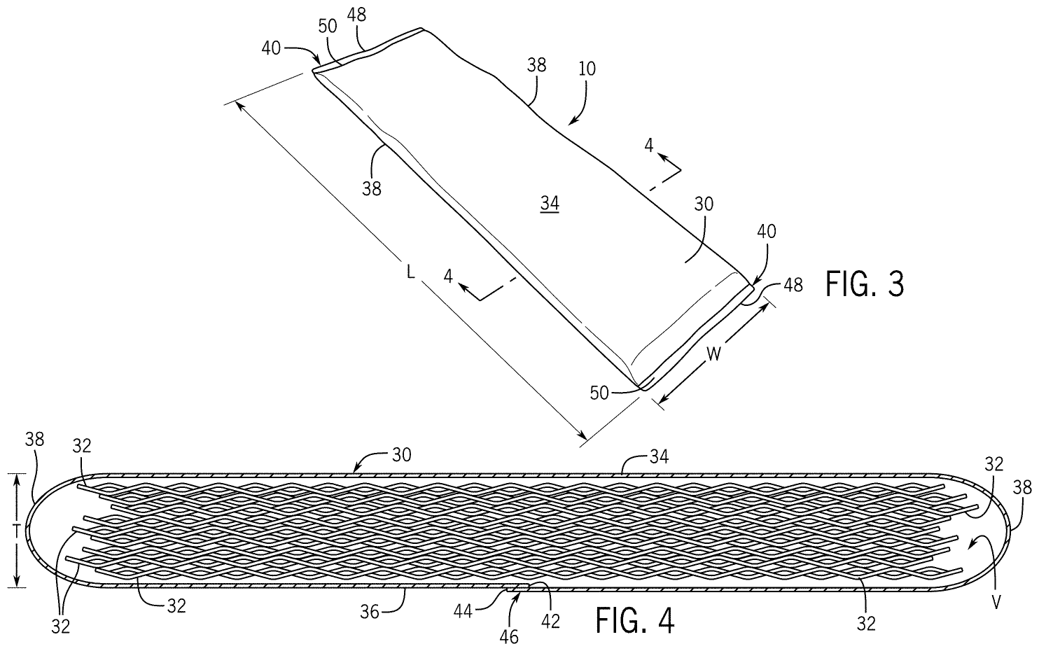

FIGS. 3 and 4 show one example of a piece, i.e., a length of the packing material 10. In this example, the disclosed packing material 10 is configured to provide insulating characteristics or properties. In the disclosed example, the packing material 10 has an outer liner or covering 30. As shown in FIG. 4, the packing material 10 also includes a plurality of inner layers, i.e., insulating layers 32 of material within and covered by the outer covering or liner 30.

In one example, the outer covering or liner 30 is formed as a paper liner or paper material. The paper material of the outer covering or liner 30 is processed, trimmed, and formed to give the packing material 10 a length L, a width W, and a thickness T, when assembled. The outer covering or liner 30 can be formed to yield a packing material 10 having a desired size and shape. The outer covering or liner 30 is configured to define an interior volume V disposed between two layers, i.e., a top layer 34 and a bottom layer 36 (see FIG. 4) of the paper material that define the length L and width W of the packing material 10. The outer covering or liner 30 also has two closed sides 38 that join the top and bottom layers 34, 36. The packing material 10 also has two opposed ends 40. The width W of the packing material 10 is defined between the sides 38 and the length L of the packing material is defined between the two opposed ends 40 in this example.

The combination of the top and bottom layers 34, 36 of the paper material forming the outer covering or liner 30 and the plurality of insulating layers 32 within the interior volume V defines the thickness T of the packing material, as depicted in FIG. 4. Any of the width W, length L, thickness T, and volume V dimensions of the packing material 10 can be varied to accommodate the needs of a particular application. The mil thickness and material type of the paper material of the outer covering or liner 30 can be varied. The number of insulating layers 32 within the interior volume V can also be varied. The characteristics of the plurality of insulating layers 32, such as the mil thickness and the substrate material can also be varied. Each of these characteristics can partially define the thickness T of the packing material 10 and can affect the insulating properties of the packing material.

The outer covering or liner 30 can be formed of a single sheet or strip of a paper substrate. The single sheet can be folded or wrapped unto itself to form the interior space or volume V and the top and bottom layers 34, 36 of the outer covering or liner 30. Two of the edges, such as the lengthwise edges 42, 44 of the single sheet that are folded over can be overlapped and joined along a seam 46. The seam 46 can be on an edge or side of the outer covering 30 (similar to the opposed end edges per below) or can be on the top layer 34 or bottom layer 36 of the outer covering (as depicted in FIG. 4). In one example, the seam 46 can be formed by gluing or otherwise adhering the two overlapped edges 42, 44 to one another. In one example, the seam 46 can be a lengthwise seam, as depicted in FIG. 4. In an alternate example, the seam 46 can be a widthwise seam on the outer covering 30 of the packing material 10, though such an example is not depicted herein. In one example, the end edges 48 of the top and bottom layers 34, 36 of the outer covering 30 at the opposed ends can overlap one another and be joined to one another to form an end seam 50. The end edges 48 of the paper substrate at the opposed ends of the outer covering 30 can also be glued or otherwise adhered to one another to form the end seams 50. The end seams can be sealed so that the interior volume V is a closed and sealed space holding a volume of air therein, along with the plurality of insulating layers 32.

As will be evident to those having ordinary skill in art, the foregoing characteristics of the packing material can be altered, depending on the application or use intended for a given design of the packing material 10. The type of paper material or substrate of the outer covering 30 and the insulating layers 32 can be varied as well, depending on the desired weight, thickness, insulation and recyclability performance characteristics, and other features intended for a given design for the packing material 10.

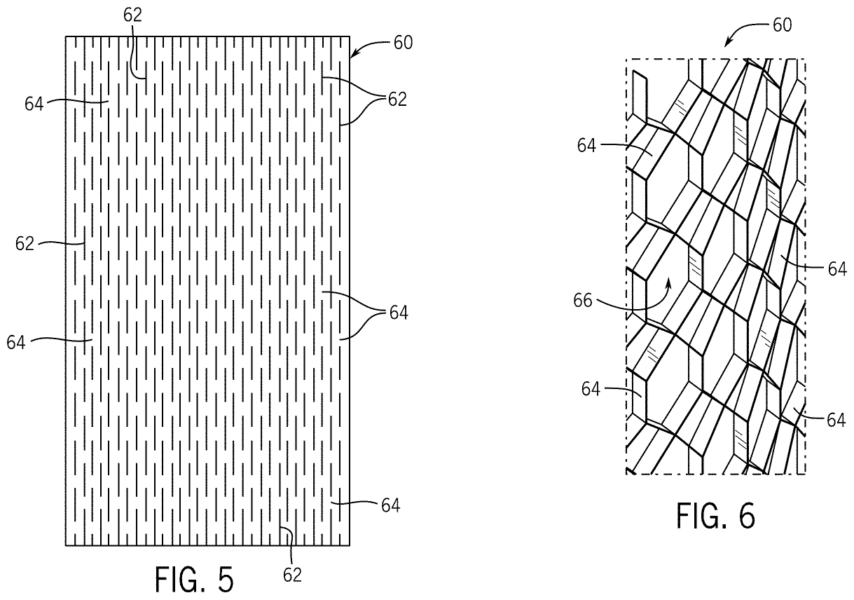

In the disclosed example, each insulating layer 32 of the plurality of insulating layers is formed from a paper substrate sheet 60, as depicted in FIG. 5. The insulating layers 32 are reconfigured from the sheet 60 to a three-dimensional shape of the insulation layer 32, as depicted in FIG. 6, and as described further below. Multiple insulating layers are then stacked parallel with each other and disposed in the interior volume V of the outer covering 30, as depicted in FIG. 4.

In the disclosed example, the packing material 10 has a length L that in many instances may be longer, and sometimes substantially longer than the width W, depending on the intended use for a given packing material design. The insulating layers 32 are also parallel with the two paper layers, i.e., the top and bottom layers 34, 36 of the outer covering 30. In one example, the length and width of the stacked insulating layers 32 substantially matches the size of the interior volume V so that little or no gaps are left in the interior volume where no insulating layer material is present. The plurality of insulating layers 32 may be trimmed so that the overlapped edges of the outer covering can be joined and sealed without interference from the paper substrate of the insulating layers.

In one example, each of the insulating layers 32 is formed by creating an array or pattern of small, closely spaced cuts or slits 62 through the paper substrate sheet 60, as depicted in FIG. 5. The paper substrate sheet 60 will thus have interconnected paper segments 64 disposed between and among the various slits or cuts 62, retaining the integrity of the single sheet. The paper substrate sheet 60 can then be elongated, i.e., tugged or pulled, such as in a lateral (widthwise) and/or an axial (lengthwise) direction, and/or in an oblique direction. In other words, the paper substrate sheet 60 with the slits or cuts 62 is stretched. Doing so can open and reconfigure the multitude of slits or cuts 62 into a multitude of holes 66 through the paper substrate, as depicted in FIG. 6, between and among the interconnected paper segments 64. Doing so also turns or rotates the portions of the paper substrate sheet 60 material, i.e., the interconnected paper segments 64 between and among the slits or cuts 62.

The slits or cuts 62 can be strategically located and dispersed over the substrate sheet 60 such that the paper segments 64 between the slits or cuts turn or rotate out of plane relative to a plane of the paper substrate sheet in a predetermined and controlled manner. The size and shape of the holes, segments, and three-dimensional configuration of the insulating layer 32 can be controlled by the length, spacing, pattern, orientation, and the like of the cuts or slits 62 in the sheet. In one example, the paper substrate sheet 60 can be configured to form a honeycomb like configuration, as generically depicted in FIG. 6. This provides each insulating layer 32 with a thickness that is much larger than the mil thickness of the material of the base paper substrate sheet 60 itself.

As a result, the stack of the plurality of insulating layers 32 will have a much greater overall thickness than that of the mil thickness of the paper substrate sheets 60 of the layers themselves. The many holes 66 through each insulating layer 32 of the stack of layers will not align perfectly with the holes in the adjacent layers of the stack. Likewise, the many interconnecting segments 64 of each insulating layer 32 of the stack of layers will not align with the segments of adjacent layers. The combination of all the misaligned holes 66 and segments 64 formed through the stack of the plurality of insulating layers 32. This creates discontinuous, circuitous air or flow paths through the insulating material layers in the direction of the thickness T of the packing material 10, as well as in directions parallel and oblique to the insulating layers, i.e., the plane of the packing material. The corresponding out of plane portions, i.e., the interconnected paper segments 64 of each insulating layer 32 of the stack of paper substrate layers combine and interact with the adjacent layers to form a relatively thick, resilient stack of insulating material layers. In one example, as shown in FIG. 6 and noted above, the number, orientation, spacing, shape, and the like of the cuts or slits 62 can be formed to create a honeycomb like structure or other suitable structures from each insulating layer 32 when a sheet 60 is expanded or extended.

The stack of insulating layers 32 of paper substrate can be formed of a plurality of individual sheets 60. The individual sheets can be separately trimmed, cut, or otherwise formed and then stacked parallel to one another to form the plurality of insulating layers 32. In another example, the stack of insulating layers 32 can be formed of one single sheet of paper substrate, expanded or extended, and then folded onto itself multiple times to form the plurality of insulating layers. In other examples, the any two or more of the insulating layers 32 can be formed from a single layer of paper substrate and folded to form sub-stacks of two or more layers. The sub-stacks can then be placed parallel to one another to form the plurality of insulating layers.

During use, the sealed and closed interior volume V and the discontinuous air flow paths within the packing material 10 help to create very good insulating properties and characteristics within the packing material 10. The stack of the expanded paper substrate sheets 60 of the plurality of insulating layers 32 also helps to provide the packing material with very good protective cushioning properties and characteristics. These characteristics can be tuned to provide suitable or specific desired insulation and cushioning properties and characteristics. For example, the paper substrate sheet 60 composition can be varied and chosen for specific characteristics. Two or more different paper substrate materials may also be used. The mil thickness of the paper substrate sheet 60 material may also be varied and chosen for specific characteristics. The length, frequency, number, and spacing of the slits or cuts in the paper substrate material may also be varied and chosen for specific characteristics.

As noted above, the outer covering or liner 30 may be formed of a recycled paper base material. The outer covering 30 may also be formed of a paper material that is recyclable. In one example, the outer covering 30 may be formed of a paper material that is both recycled and recyclable. In one example, the outer covering 30 may be made of a paper material that is 100% recycled paper, that is 100% recyclable paper, or both. One or more layers of the plurality of insulating layers 32 may also be formed of a recycled paper base material. One or more layers of the plurality of insulating layers may also be formed of a paper material that is recyclable. In one example, the insulating layers 32 may be formed of a paper material that is both recycled and recyclable. In one example, the plurality of insulating layers 32 may each be made of a paper material that is 100% recycled paper, that is 100% recyclable paper, or both. In one example, both the outer covering and the plurality of insulating layers are all made of 100% recycled and recyclable paper. This configuration will yield a packing material 10 that is entirely green while also being lightweight, being inexpensive to manufacture, and providing very good cushioning and insulating properties and characteristics in comparison to other like packing materials.

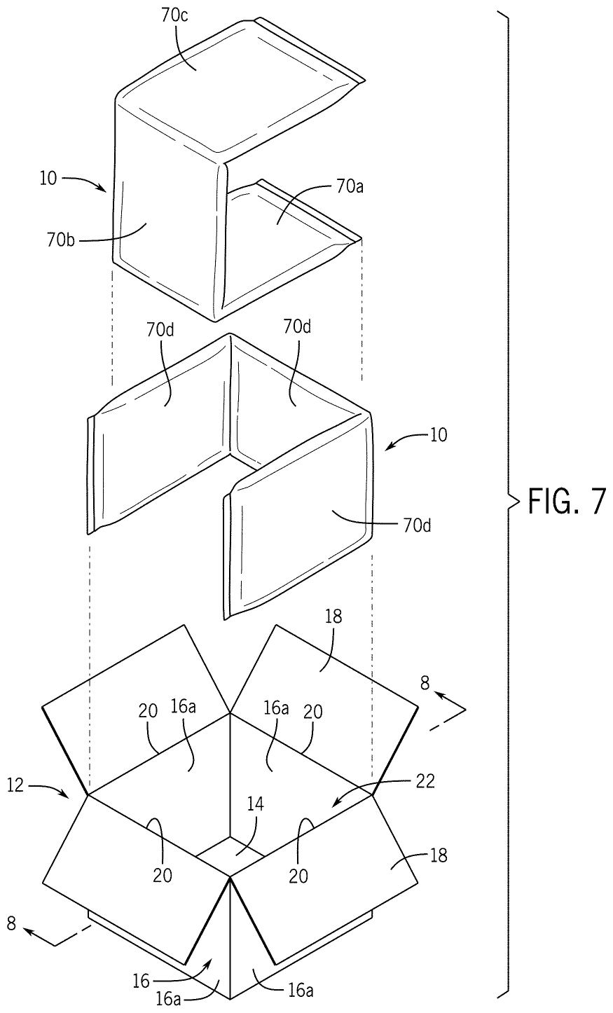

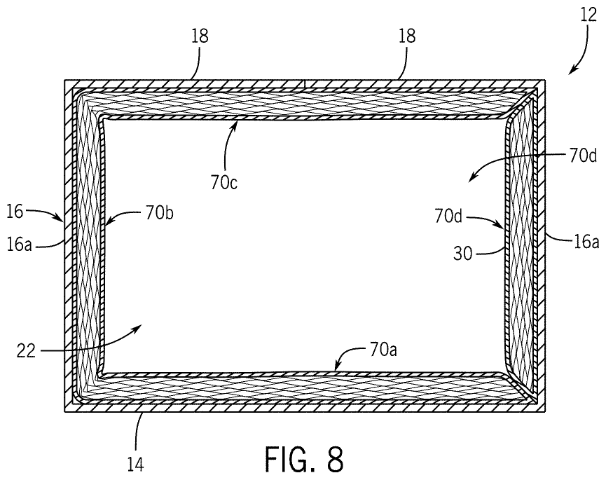

As noted above, many features and aspects of the packing material 10 as well as the shipping container and the shipped products can vary. FIGS. 7 and 8 depict just one alternative example for arranging the packing material within a box 12 to fully encompass a product to be shipped. In this example, the box 12 is no different than the box 12 in FIG. 1 and described above. Instead, in this example, the packing material 70 is provide in two similar or identical parts. Each part is a length of the packing material 70, folded twice to form three distinct panel sections 70a. One length of the packing material 70 is oriented horizontally and then placed in the box 12. One section 70a resides horizontally against the bottom 14 of the box 12. One section 70b resides vertically against one wall 16a of the upstanding sidewall 16 of the box. One section 70c resides horizontally against the flaps 18, when the box is closed. The other part of the packing material 70 is oriented vertically, in the same manner as described above with respect to the box 12 of FIGS. 1 and 2. Each of the three sections 70c of the other part of the packing material 70 will reside vertically against one of the three remaining walls 16a of the upstanding side wall 16 of the box 12. FIG. 8 shows a cross section depicting the two folds and each of the three sections 70a, 70, 70c of the one horizontally oriented part of the packing material 70 and one of the vertical sections 70d of the other part of the packing material.

Other arrangements of the disclosed packing material are certainly possible. Other sizes and shapes of the packing material are also possible within the scope f the present disclose. The packing material can be designed to accommodate the size and shape of a given shipping container and can be configured to cover any desired surface or surfaces within the container. Details of the packing material can also vary from the examples shown herein. The mid seams and/or end seams can be folded, adhered, attached, connected, bonded, or otherwise joined to one another in any number of ways. The interior volume can be semi-sealed or closed using seams with limited seal integrity, such as by stapling, if desired. Alternatively, the interior volume can be completely sealed using seals with complete leak-proof integrity. The air containment or leak characteristics of the interior volume V can be determined by the integrity of the seals as well as the permeability of the paper substrate of the outer covering 30. Many characteristics of the disclosed shipping containers and packing materials can be varied, manipulated, selected, and controlled to achieve a desired effect.

Testing has shown that the insulating properties and characteristics of the disclosed packing material are superior to the aforementioned existing packing materials used for shipping temperature sensitive products direct to consumers. However, the disclosed packing material is certainly not limited to such uses. The packing material may also be used strictly for its cushioning properties, lightweight benefits, and inexpensive cost.

Although certain packing materials, constructions, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A packing material comprising:
an outer covering formed of paper and configured to have a length, a width, a thickness, and an interior volume defined within the outer covering; and
a plurality of insulating layers each formed of paper substrate and stacked and disposed within the interior volume,
wherein each of the plurality of insulating layers is configured having a three-dimensional out of plane configuration with an expanded thickness.

2. The packing material of claim 1, wherein the outer covering is formed of recycled paper.

3. The packing material of claim 1, wherein the outer covering is formed of recyclable paper.

4. The packing material of claim 3, wherein the outer covering is formed of recycled paper.

5. The packing material of claim 1, wherein the plurality of insulating layers is each formed of recycled paper.

6. The packing material of claim 1, wherein the plurality of insulating layers is each formed of recyclable paper.

7. The packing material of claim 6, wherein the plurality of insulating layers is each formed of recycled paper.

8. The packing material of claim 1, wherein the plurality of insulating layers and the outer covering are each formed of recycled paper.

9. The packing material of claim 1, wherein the plurality of insulating layers and the outer covering are each formed of recyclable paper.

10. The packing material of claim 9, wherein the plurality of insulating layers and the outer covering are each formed of recycled paper.

11. The packing material of claim 1, wherein the outer covering is made from 100% recycled and/or recyclable paper.

12. The packing material of claim 1, wherein the plurality of insulating layers is each made from 100% recycled and/or recyclable paper.

13. The packing material of claim 1, wherein the outer covering and the plurality of insulating layers are each made from 100% recycled and recyclable paper.

14. The packing material of claim 1, wherein the outer covering is a sheet of paper folded or wrapped unto itself to form the interior volume and includes a lengthwise seam.

15. The packing material of claim 1, wherein the outer covering is a sheet of paper folded or wrapped unto itself to form the interior volume and includes widthwise ends seams.

16. The packing material of claim 1, wherein the outer covering includes one or more sealed seams such that the interior volume is a closed and sealed space.

17. The packing material of claim 1, wherein each of the plurality of insulating layers is an expanded sheet of paper material having a plurality of slits.

18. The packing material of claim 1, wherein the plurality of insulating layers is a layered stack of individual insulating layers of material.
